(19) United States
(12) Patent Application Publication
(10) Pub. No.: US 2022/0323890 A1
(43) Pub. Date: Oct. 13, 2022

(54) FILTER ASSEMBLY, PREFILTER ASSEMBLY, AND RESPIRATOR INCLUDING THE SAME

(71) Applicant: 3M INNOVATIVE PROPERTIES COMPANY, St. Paul, MN (US)

(72) Inventors: Nathan E. Schultz, Woodbury, MN (US); Daniel C. Duan, St. Paul, MN (US); Seth M. Kirk, Minneapolis, MN (US); Michael R. Berrigan, Oakdale, MN (US); Zackary J. Becker, Minneapolis, MN (US); Fuming B. Li, Woodbury, MN (US); John M. Sebastian, Oakdale, MN (US)

(21) Appl. No.: 17/622,045

(22) PCT Filed: Jun. 12, 2020
(86) PCT No.: PCT/IB2020/055548

§ 371 Date: Dec. 22, 2021

Related U.S. Application Data
(60) Provisional application No. 62/867,941, filed on Jun. 28, 2019.

(51) Int. Cl. B01D 39/16; A62B 23/02

(52) U.S. Cl. CPC B01D 39/1623; A62B 23/025; B01D 2239/0233; B01D 2239/0407; B01D 2239/0435; B01D 2239/0618; B01D 2239/065; B01D 2239/0622

(57) ABSTRACT

A filter assembly comprises an air filter medium and a prefilter medium. The prefilter medium comprises a second nonwoven fibrous web comprising poly(4-methylpentene) and an electrostatic charging additive and has a second electret charge. The filter assembly is configured such that air passing through the prefilter is directed through the air filter medium. A respirator includes the filter assembly. A prefilter assembly comprises a third nonwoven fibrous web retained by a prefilter frame. The third nonwoven fibrous web comprises: core-sheath fiber comprising a fiber core having a poly(4-methylpentene) sheath layer disposed thereon; and an electrostatic charging additive, wherein the electrostatic charging additive is contained in at least one of the fiber core or the sheath layer. The third nonwoven fibrous web has a third electret charge.

### TECHNICAL FIELD

The present disclosure broadly relates to air filtration media, nonwoven fibrous webs, and articles including the same.

### BACKGROUND

Air that contains toxic or noxious substances is often filtered (e.g., using a respirator or HVAC filter) to remove those substances.

Respirator certification is regulated by the National Institute for Occupational Safety and Health (NIOSH) in the United States of America. NIOSH establishes various removal efficiency Standards for respirators that have been challenged with different contaminants. For example, a standard for oily-mist removal efficiency-using suspended droplets of dioctyl phthalate (DOP)-must be met by filter media designated for use in environments where oil is present. Because removal efficiency may change in response to oil-loading, the standards specify a minimum removal efficiency over a fixed exposure to a challenge aerosol. Other regulatory agencies may use paraffin oil or different oils.

Effective July 1995, NIOSH instituted standards for nonpowered air-purifying particulate respirators (see 42 C.F.R. Part 84, published Jun. 8, 1995). The regulations include several different classifications, one of which is commonly referred to as “P-series' and is directed at filters that are intended for removal of oil-based liquid particulates. For a P-series certification, the respirator filter media must exhibit nondecreasing efficiency at the end point of a DOP removal efficiency test.

Fibrous electret filter media have been used in particulate air filters for many years. The quasi-permanent electrostatic charge on electret filter media enhances their filtration efficiency over that of purely mechanical filters. The enhanced efficiency results in an electret filter with less air flow resistance (lower pressure drop) than a mechanical filter with the same efficiency and surface area. Respirators utilizing electret filter media can generally be made lighter in weight and more compact than those made from mechanical filter media.

However, the efficiency of electret filter media can be reduced by exposure to certain aerosols; mechanical filters are generally more resistant to this type of efficiency loss. NIOSH regulation 42 CFR 84 requires, for certification of negative pressure respiratory protection devices, passage of an air filtration test that minimum filtration efficiencies during loading of the respirator with a specified amount of most penetrating-size particles of solid sodium chloride aerosol or oily liquid dioctyl phthalate (DOP) aerosol. These loading tests have been shown to decrease the filtration efficiency of certain types of electret filter media.

For example, liquid aerosols from oils such as DOP that have a relatively high dielectric constant can decrease the filtration efficiency of electret filters. Liquid aerosols can also wet the fiber surface. Possible mechanisms for loss of filtration efficiency of electrostatic filters caused by certain aerosols include the following: (1) neutralization of the charge on the fiber by opposite charges on the captured aerosol particles, (2) screening of the fiber charge by a layer of captured particles, and (3) disruption of the charge-carrying part of the fiber by the aerosol, either by dissolution of the surface layer or by chemical reaction.

### SUMMARY

There remains a need for new filter devices that can remove oily aerosols from an air stream while maintaining acceptable filtration performance for extended periods of time. The present disclosure addresses this need by providing a filter assembly suitable for use with an electret nonwoven fiber air filter medium in an air filter medium assembly. The air filter assembly exhibits stable efficiency for removal of oily aerosols and particulate matter.

Accordingly, in one aspect, the present disclosure provides a filter assembly comprising:

an air filter comprising a first nonwoven fibrous web having a first electret charge, and wherein the first nonwoven fibrous web comprises at least one of polypropylene, polyester, polystyrene, or polyethylene; and

a prefilter medium comprising a second nonwoven fibrous web having a second electret charge and comprising poly(4-methylpentene) and an electrostatic charging additive,

wherein the filter assembly is configured such that air passing through the prefilter medium is directed through the air filter medium.

In another aspect, the present disclosure provides a respirator comprising a filter assembly according to the present disclosure.

In another aspect, the present disclosure provides a prefilter assembly comprising:

a prefilter frame having an inlet opening and an outlet opening; and

a prefilter medium retained by prefilter frame, the prefilter medium comprising a nonwoven fibrous web having an electret charge and comprising:
a thermoplastic core-sheath fiber comprising a fiber core having a sheath layer comprising poly(4-methylpentene) disposed thereon; and
an electrostatic charging additive, wherein the electrostatic charging additive is contained in at least one of the fiber core or the sheath layer.

Advantageously, filter assemblies according to the present disclosure, which may include a prefilter assembly according to the present disclosure, may exhibit sustained desirable filter performance properties over an extended use even in the presence of an oily aerosol.

As used herein:

the term “4-methylpentene refers to 4-methyl-1-pentene;

the term “poly(4-methyl-1-pentene) refers to polymers (homopolymers and copolymers) containing at least 90 weight percent of 4-methylpentan-1,2-diyl) (i.e.,

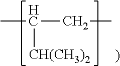

monomeric units and optionally up to 10 weight percent (e.g., up to 10 weight percent, up to 9 weight percent, up to 8 weight percent, up to 7 weight percent, up to 6 weight percent, up to 5 weight percent, up to 4 weight percent, up to 3 weight percent, up to 2 weight percent, up to 1 weight percent) of at least alkylene (e.g., ethylene, propylene, butylene, pentylene, hexylene, isooctylene) monomeric units; and

the term “electret charge” means that there is at least quasi-permanent electrical charge, where “quasi-permanent’ means that the electric charge is present under standard atmospheric conditions (22° C., 101,300 Pascals atmospheric pressure, and 50% relative humidity) for a time period long enough to be significantly measurable. Electric charge may be characterized by the X-ray Discharge Test as described in U.S. Pat. No. 9,815,067 (Schultz et al.) in col. 18, lines 12-42, incorporated herein by reference.

Features and advantages of the present disclosure will be further understood upon consideration of the detailed description as well as the appended claims.

### BRIEF DESCRIPTION OF THE DRAWINGS

FIG. 1 is a schematic cross-sectional view of an exemplary filter assembly 100 according to the present disclosure.

FIG. 2. is a schematic cross-sectional view of an exemplary core-sheath fiber 200 useful in practice of the present disclosure.

FIG. 3 is a perspective view of an exemplary prefilter assembly 300 according to the present disclosure.

FIG. 4 is a schematic front view of an exemplary respirator 40 according to one embodiment of the present disclosure.

FIG. 5 is a schematic cross-sectional view of mask body 42 in FIG. 4.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

Referring now to FIG. 1, filter assembly 100 comprises air filter medium 110 and prefilter medium 120. Filter assembly 100 is configured such that air 130 passing through prefilter medium 120 is directed through air filter medium 110. Air filter medium 110 comprises a first nonwoven fibrous web 112 which has a first electret charge and comprises at least one of polypropylene, polyester, polystyrene, or polyethylene. Prefilter medium 120 comprises a second nonwoven fibrous web 122, which has a second electret charge and comprises poly(4-methylpentene) and an electrostatic charging additive.

The first nonwoven fibrous web comprises a plurality of interconnected and/or entangled fibers. Generally, the fibers comprise at least one of polypropylene, polyester, polystyrene, or polyethylene. However, if desired a blend of these fibers with other materials (e.g., in particulate and/or fiber form) may also be used.

The second nonwoven fibrous web comprises a plurality of interconnected and/or entangled fibers. comprising poly(4-methyl-1-pentene). In some preferred embodiments, the fibers also comprise a thermoplastic component other than poly(4-methyl-1-pentene). In such embodiments, the fibers may comprise core-sheath fibers as discuss hereinbelow. However, if desired a blend of the fibers with other materials (e.g., in particulate and/or fiber form) may also be used.

Fibers comprising the fiber materials listed may be combined with additional fibers to form the nonwoven fibrous web(s). The fibers may comprise any material, organic or inorganic. For example, the fibers may comprise ceramic fibers, glass fiber, glass-ceramic fibers, natural fibers, or synthetic fibers.

Preferably, synthetic fibers comprise at least one thermoplastic polymer. Exemplary thermoplastic polymers include styrenic block copolymers (e.g., SIS, SEBS, SBS), thermoplastic polyolefins, elastomeric alloys (e.g., elastomeric thermoplastic acrylate block copolymers such as polymethyl methacrylate-block-poly(butyl acrylate)-block-polymethyl methacrylate commercially available as Kurarity from Kuraray Company, Ltd., Okayama, Japan), thermoplastic polyurethanes (TPUs), thermoplastic polyesters and copolyesters; polyvinyl chloride; polystyrene; polycarbonates; thermoplastic polyesters (e.g., polylactides and polyethylene terephthalate); perfluorinated polymers and copolymers, thermoplastic polyamides, and blends of any of the foregoing.

Thermoplastic polyesters may include, for example, polylactic acid and polycaprolactone. Melt-processable (filament-forming) polylactic acid polymer materials (e.g., L-D copolymers) are commercially available e.g. from Natureworks LLC of Minnetonka, Minn., under the trade designations INGEO 6100D, 6202D, and 6260D. Melt-processable polylactic acid polymer materials (e.g., D-lactic acid homopolymers) are available, e.g., from Synbra Technologies, The Netherlands, as SYNTERRA PDLA 1010. Many other potentially suitable polylactic acid materials are also available.

Exemplary thermoplastic polyurethanes (TPUs) include polyester-based TPUs and polyether-based TPUs. One exemplary polyester-based thermoplastic polyurethane can be obtained as IROGRAN (model PS 440-200) from The Huntsman Corporation (The Woodlands, Tex.). Exemplary polyether TPU resins include those commercially available as Estane from B.F. Goodrich Company (Cleveland, Ohio).

Exemplary thermoplastic polyolefins include homopolymers and copolymers of propylene, ethylene, 1-butene, 1-hexene, 1-octene, 1-decene, 4-methyl-1-pentene, and 1-octadecene. Of these, homopolymers and copolymers of ethylene and/or propylene are preferred, with ethylene being generally preferred. Representative examples include polyethylene (e.g., HDPE, LDPE, LLDPE, VLDPE; ULDPE, UHMW-PE grades), polypropylene, poly(l-butene), poly(3-methylbutene), poly(4-methyl-1-pentene) and copolymers of olefinic monomers discussed herein.

Examples of suitable thermoplastic resins include, for example, the polypropylene resins: ESCORENE PP 3746G commercially available from Exxon-Mobil Corporation, Irving, Tex.; TOTAL PP3960, TOTAL PP3860, and TOTAL PP3868 commercially available from Total Petrochemicals USA Inc., Houston, Tex.; and METOCENE MF 650 W commercially available from LyondellBasell Industries, Inc., Rotterdam, Netherlands; and the poly-4-methyl-1-pentene resin TPX-MX002 commercially available from Mitsui Chemicals, Inc., Tokyo, Japan.

Nonwoven fibrous webs used in the present disclosure may have any basis weight, thickness, porosity, and/or density unless otherwise specified. Nonwoven fibrous webs used in the present disclosure may have any basis weight and thickness, for example, from 1 g/m² (gsm) to 400 gsm, 1 gsm to 200 gsm, 10 gsm to 200 gsm, 50 gsm to about 200 gsm, or even 100 gsm to about 200 gsm. In some embodiments, the nonwoven fibrous webs are lofty open nonwoven fibrous webs.

Nonwoven fibrous webs may be made, for example, by conventional air laid, carded, stitch bonded, spunbonded, wet laid, meltspun, and/or melt-blown procedures, preferably melt-blown, meltspun, and/or spunbonded.

Spunbonded nonwoven fibrous webs can be formed according to well known conventional methods wherein meltspun fibers are deposited on a moving belt where they form a nonwoven continuous fiber web having interfiber bonds. Melt-blown nonwoven fibrous webs are made by a similar process except that high velocity gas impinges on the extruded fibers thereby stretching and thinning them before they are collected on a rotating drum. Melt-blown fiber webs likewise have interfiber bonds, although the webs generally do not have the cohesive strength of corresponding spunbonded fiber webs.

Melt-blowing methods are well-known in the art. As used herein, the term “melt-blown” refers to a process in which fibers are formed by extruding a molten thermoplastic material through a plurality of fine, usually circular, die capillaries into a high velocity gas (e.g., air) stream which attenuates the molten thermoplastic material and forms fibers, which can be to microfiber diameter, such as less than 10 microns in diameter. Thereafter, the melt-blown fibers are carried by the gas stream and are deposited on a collecting surface to form a web of random melt-blown fibers. Such a process is disclosed, for example, in U.S. Pat. No. 3,849,241 (Butin, et al.); U.S. Pat. No. 4,307,143 (Meitner, et al.); and U.S. Pat. No. 4,707,398 (Wisneski, et al.). Optionally, the melt-blowing process may further comprise at least one of addition of a plurality of staple fibers to the plurality of discrete, discontinuous, multi-component fibers, or addition of a plurality of particulates to form a composite nonwoven fibrous web.

In some embodiments, a nonwoven web can be made by air-laying of fibers (e.g., core-sheath fibers and optional secondary fibers). Air-laid nonwoven fibrous webs may be prepared using equipment such as, for example, that available as a RANDO WEBBER from Rando Machine Company of Macedon, N.Y. In some embodiments, a type of air-laying may be used that is termed gravity-laying, as described, e.g., in U. S. Pat. Application Publication 2011/0247839 to Lalouch, the disclosure of which is incorporated by reference herein.

Nonwoven fibrous webs may be densified and strengthened, for example, by techniques such as crosslapping, stitchbonding, needletacking, hydroentangling, chemical bonding, and/or thermal bonding.

The first and second nonwoven fibrous webs comprise at least one charge enhancing additive, which may be the same or different. Many charge enhancing additives for making electret-containing fiber webs are known in the art. Exemplary electrostatic charge enhancing additives may include pigments, light stabilizers, primary and secondary antioxidants, metal deactivators, hindered amines, hindered phenols, metal salts, phosphite triesters, phosphoric acid salts, fluorine-containing compounds, and combinations thereof.

Exemplary charge-enhancing additives include thermally stable organic triazine compounds or oligomers, which compounds and/or oligomers contain at least one nitrogen atom in addition to those in the triazine ring, see, for example, U.S. Pat. Nos. 6,268,495; 5,976,208; 5,968,635; 5,919,847; and 5,908,598 all to Rousseau et al.

Another charge-enhancing additive known to enhance electrets is “CHIMASSORB 944: (poly[[6-(1,1,3,3,-tetramethylbutyl) amino]-s-triazine-2,4-diyl][[(2,2,6,6-tetramethyl-4-piperidyl) imino] hexamethylene [(2,2,6, 6-tetramethyl-4-piperidyl) imino]]), available from BASF, Ludwigshafen, Germany.

The charge-enhancing additives may be N-substituted amino aromatic compounds, particularly tri-amino substituted compounds, such as 2,4,6-trianilino-p-(carbo-2′-ethylhexyl-1′-oxy)-1,3,5-triazine, available as UVINUL T-150 from BASF, Ludwigshafen, Germany. Another charge additive is 2,4,6-tris-(octadecylamino)-triazine, also known as tristearyl melamine (“TSM”).

Further examples of charge-enhancing additives are provided in U. S. Publ. Pat. Appln. No. 2011/0137082 (Li et al.). U.S. Pat. No. 8,613,795 (Li et al.), U.S. Pat. No. 7,390,351 (Leir et al.), U.S. Pat. No. 5,057,710 (Nishiura et al.), and U.S. Pat. Nos. 4,652,282 and 4,789,504, both to Susumu et al., and U.S. Pat. No. 8,790,449 B2 (Li et al.).

In some embodiments, the electrostatic charging additive is selected from the group consisting of pigments, light stabilizers, primary and secondary antioxidants, metal deactivators, hindered amines, hindered phenols, metal salts, phosphite triesters, phosphoric acid salts, fluorine-containing compounds, and combinations thereof.

Preferably, any charge-enhancing additives are included in molten thermoplastic prior to extrusion to form a thermoplastic fiber, although this is not a requirement.

Fibers (also including core-sheath fibers) included in nonwoven fibrous webs of the present disclosure may be charged as they are formed, or charged after they are formed. For electret filter media (e.g., a nonwoven fibrous web), the media is generally charged after the fiber web is formed.

In general, any standard charging method known in the art may be used. For example, charging may be carried out in a variety of ways, including tribocharging and corona discharge. A combination of methods may also be used. As mentioned above, in some embodiments, the electret webs of this disclosure have the desirable feature of being capable of being charged by corona discharge alone, particularly DC corona discharge, without the need of additional charging methods. Examples of suitable corona discharge processes are described in U.S. Pat. Re. No. 30,782 (van Turnhout), U.S. Pat. Re. No. 31,285 (van Turnhout), U.S. Pat. Re. No. 32,171 (van Turnhout), U.S. Pat. No. 4,215,682 (Davis et al.), U.S. Pat. No. 4,375,718 (Wadsworth et al.), U.S. Pat. No. 5,401,446 (Wadsworth et al.), U.S. Pat. No. 4,588,537 (Klaase et al.), U.S. Pat. No. 4,592,815 (Nakao), U.S. Pat. No. 6,365,088 (Knight et al.), British Pat. 384,052 (Hansen), U.S. Pat. No. 5,643,525 (McGinty et al.), Japanese Pat. No. 4,141,679 B2 (Kawabe et al.). Further methods are discussed by M. Paajanen et. al. in Journal of Physics D: Applied Physics (2001), vol. 34, pp. 2482-2488, and by G. M. Sessler and J. E. West in Journal of Electrostatics (1975), 1, pp. 111-123.

Another technique that can be used to charge the electret web is hydrocharging. Hydrocharging of the web is carried out by contacting the fibers with water in a manner sufficient to impart a charge to the fibers, followed by drying of the web. One example of hydrocharging involves impinging jets of water or a stream of water droplets onto the web at a pressure sufficient to provide the web with filtration enhancing electret charge, and then drying the web. The pressure necessary to achieve optimum results varies depending on the type of sprayer used, the type of polymer from which the web is formed, the type and concentration of additives to the polymer, the thickness and density of the web and whether pre-treatment, such as corona surface treatment, was carried out prior to hydrocharging. Generally, water pressures in the range of about 10 to 500 psi (69 to 3450 kPa) are suitable. The jets of water or stream of water droplets can be provided by any suitable spray device. One example of a useful spray device is the apparatus used for hydraulically entangling fibers. An example of a suitable method of hydrocharging is described in U.S. Pat. No. 5,496,507 (Angadjivand et al.). Other methods are described in U.S. Pat. No. 6,824,718 (Eitzman et al.), U.S. Pat. No. 6,743,464 (Insley et al.), U.S. Pat. No. 6,454,986 (Eitzman et al.), U.S. Pat. No. 6,406,657 (Eitzman et al.), and U.S. Pat. No. 6,375,886 (Angadjivand et al.). The hydrocharging of the web may also be carried out using the method disclosed in the U.S. Pat. No. 7,765,698 (Sebastian et al.).

Core-sheath fiber and/or nonwoven fibrous web containing core-sheath fiber may be charged as it is formed, or charged after it is formed. For electret filter media (e.g., a nonwoven fibrous web), the media is generally charged after the fiber web is formed.

In preferred embodiments, the second nonwoven fibrous web (i.e., of the prefilter medium) comprises core-sheath fibers having a fiber core and a sheath layer.

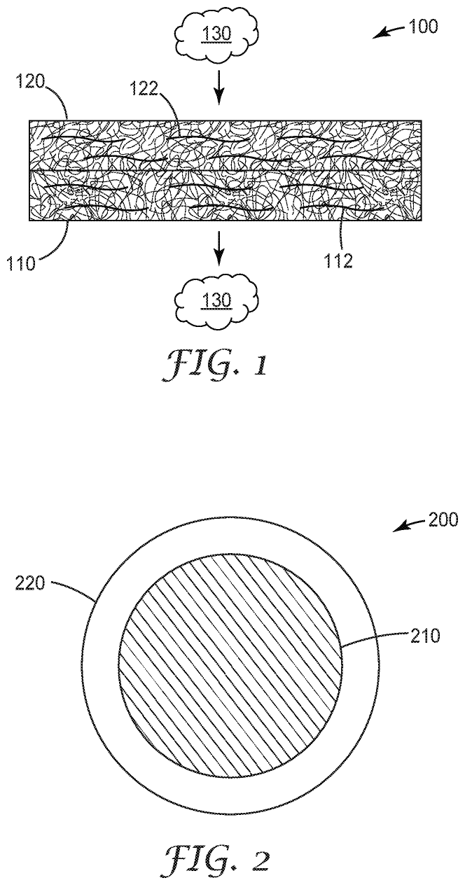

Referring now to FIG. 2, exemplary core-sheath fiber 200 comprises a fiber core 210 having a sheath layer 220 comprising poly(4-methylpentene) disposed thereon. Electrostatic-charging additive is contained in at least one of fiber core 210 or sheath layer 220. While not shown, the sheath layer 220 is coextensive along the fiber length (fiber ends excluded). Sheath layer 220 comprises poly(4-methylpentene). While the core-sheath fiber and the fiber core shown in FIG. 2 have circular cross-sections, other cross-sections may also be used such as, for example, triangular, square, rectangular, pentagonal, hexagonal, heptagonal, octagonal, star-shaped, oval, trilobal, and tetralobal. Likewise, while FIG. 2 shows a centrally located fiber core, it may be located off-center. In some embodiments, multiple fiber cores (e.g., 2, 3, 4, 5, 6, 7, or 8 fiber cores) may be present.

The fiber core may comprise any material, organic or inorganic. For example, the fiber core may comprise ceramic fibers, glass fiber, glass-ceramic fibers, natural fibers, or synthetic fibers.

Preferably, the fiber core comprises at least one thermoplastic polymer as disclosed hereinbefore. In some embodiments, the fiber core comprises a thermoplastic polymer capable of retaining a high quantity of trapped electrostatic charge. Thermoplastic polymers useful in the present disclosure that are capable of retaining a high quantity of trapped electrostatic charge when formed into a web and charged. Typically, such resins have a DC (direct current) resistivity of greater than 10¹⁴ ohm-cm at the temperature of intended use. Polymers capable of acquiring a trapped charge include polyolefins such as polypropylene, polyethylene (e.g., HDPE, LDPE, LLDPE, VLDPE; ULDPE, UHMW-PE grades), and poly-4-methyl-1-pentene (e.g., poly-4-methyl-1-pentene resin TPX-DX820, TPX-DX470, TPX-MX002 commercially available from Mitsui Chemicals, Inc., Tokyo, Japan); polyvinyl chloride; polystyrene; polycarbonates; polyesters, including polylactides; and perfluorinated polymers and copolymers. Particularly useful materials include polypropylene, poly-4-methyl-1-pentene, blends thereof or copolymers formed from at least one of propylene and 4-methyl-1-pentene.

Examples of suitable thermoplastics include polypropylenes available as, for example, ESCORENE PP 3746G commercially available from Exxon-Mobil Corporation, Irving, Tex.; TOTAL PP3960, TOTAL PP3860, and TOTAL PP3868 commercially available from Total Petrochemicals USA Inc., Houston, Tex.; METOCENE MF 650 W commercially available from LyondellBasell Industries, Inc., Rotterdam, Netherlands; and the poly-4-methyl-1-pentene resin TPX-MX002 commercially available from Mitsui Chemicals, Inc., Tokyo, Japan.

The fiber core may further comprise one or more conventional adjuvants such as antioxidants, light stabilizers, plasticizers, acid neutralizers, fillers, antimicrobials, surfactants, antiblocking agents, pigments, primers, dispersants, and other adhesion promoting agents. It may be particularly beneficial for medical applications to incorporate the antimicrobials and enhancers discussed in U.S. Pat. No. 7,879,746 (Klun et al.), incorporated herein by reference. It may be particularly beneficial for certain applications to incorporate surfactants discussed in U. S. Pat. Appl. Publ. No. 2012/0077886 (Scholz et al.), incorporated herein by reference.

The fiber core may have any average diameter, but preferably is in a range of from 1 to 100 microns, more preferable 5 to 50 microns, and even more preferably 10 to 25 microns.

The sheath layer comprises poly(4-methyl-1-pentene). It forms a coextensive sheath layer with the outer surface of the fiber core, exclusive of the ends of the fiber core which are generally not coated with the sheath layer. While not a requirement, the sheath layer is preferably substantially uniform and complete. The sheath layer may have any thickness, but is preferably from 1 to 8 microns, more preferably 1 to 5 microns in average thickness. In some preferred embodiments, the sheath layer comprises 1 to 40 percent by weight of the thermoplastic core-sheath fiber; however, other amounts may also be used.

At least one of the fiber core and the sheath layer may contain an electrostatic charge enhancing additive. Exemplary charge-enhancing additives are listed hereinbefore.

In addition, fibers and/or nonwoven fibrous webs may be treated to chemically modify their surfaces.

The charge-enhancing additive(s) can be added in any suitable amount. The charge-enhancing additives of this disclosure may be effective even in relatively small quantities. Typically, the charge-enhancing additive is present in a thermoplastic resin and charge-enhancing additive blend in amounts of up to about 10% by weight, more typically in the range of 0.02 to 5% by weight based upon the total weight of the blend. In some embodiments, the charge-enhancing additive is present in an amount ranging from 0.1 to 3% by weight, 0.1 to 2% by weight, 0.2 to 1.0% by weight, or 0.25 to 0.5% by weight.

Blends of the thermoplastic polymer and the charge-enhancing additive can be prepared by well-known methods. Typically, the blend is processed using melt extrusion techniques, so the blend may be preblended to form pellets in a batch process, or the thermoplastic resin and the charge-enhancing additive may be mixed in the extruder in a continuous process. Where a continuous process is used, the thermoplastic resin and the charge-enhancing additive may be pre-mixed as solids or added separately to the extruder and allowed to mix in the molten state.

Examples of melt mixers that may be used to form preblended pellets include those that provide dispersive mixing, distributive mixing, or a combination of dispersive and distributive mixing. Examples of batch methods include those using a BRABENDER (e. g. a BRABENDER PREP CENTER, commercially available from C.W. Brabender Instruments, Inc.; South Hackensack, N.J.) or BANBURY internal mixing and roll milling equipment (e.g. equipment available from Farrel Co.; Ansonia, Conn.). After batch mixing, the mixture created may be immediately quenched and stored below the melting temperature of the mixture for later processing.

Examples of continuous methods include single screw extruding, twin screw extruding, disk extruding, reciprocating single screw extruding, and pin barrel single screw extruding. The continuous methods can include utilizing both distributive elements, such as cavity transfer mixers (e.g. CTM, commercially available from RAPRA Technology, Ltd.; Shrewsbury, England) and pin mixing elements, static mixing elements or dispersive mixing elements (commercially available from e.g., MADDOCK mixing elements or SAXTON mixing elements).

Examples of extruders that may be used to extrude preblended pellets prepared by a batch process include the same types of equipment described above for continuous processing. Useful extrusion conditions are generally those which are suitable for extruding the resin without the additive.

Fibers used in practice of the present disclosure (including core-sheath fibers) may have any average fiber diameter, and may be continuous, random, and/or staple fibers. For example, in some embodiments, the fibers (i.e., individual fibers) may have an average fiber diameter of greater than or equal to 11 microns (e.g., greater than or equal to 12 microns, greater than or equal to 15 microns, greater than or equal to 20 microns) up to 25 microns, up to 26 microns, up to 27 microns, up to 28 microns, up to 29 microns, up to 30 microns, up to 35 microns, up to 40 microns, or even up to 50 microns). In some preferred embodiments, the fiber has an average diameter of, preferably 10-50 microns, more preferably 15-40, more preferably 20 to 30 microns or even 20 to 25 microns).

Methods for making core-sheath fibers are well known and need not be described here in detail. To form a core sheath fiber, generally, at least two polymers are extruded separately and fed to a polymer distribution system where the polymers are introduced into a segmented spinneret plate. The polymers follow separate paths to the fiber spinneret and are combined in a spinneret hole which comprises, for example, either at least two concentric circular holes thus providing a core-sheath type fiber. Other configurations are also contemplated. The combined polymer filament is then cooled, solidified, and drawn, generally by a mechanical rolls system, to an intermediate filament diameter and collected. Subsequently, the filament may be “cold drawn” at a temperature below its softening temperature, to the desired finished fiber diameter and crimped or texturized and cut into a desirable fiber length. Core-sheath fibers can be cut into relatively short lengths, such as staple fibers which generally have lengths in the range of about 25 to about 50 millimeters and short-cut fibers which are even shorter and generally have lengths less than about 18 millimeters. See, for example, U.S. Pat. No. 4,789,592 (Taniguchi et al.) and U.S. Pat. No. 5,336,552 (Strack et al.).

Fibers (filaments) described herein can generally be made using techniques known in the art for making filaments. Such techniques include wet spinning, dry spinning, melt spinning, melt blowing, or gel spinning.

Particularly advantageous to form core-sheath filaments is melt spinning. In melt spinning, a polymer is heated, passed through a spinneret, and fibers solidify upon cooling. For example, a melt spinning process can occur to collect the multicomponent filaments. The term “meltspun” as used herein refers to filaments that are formed by extruding molten filaments out of a set of orifices and allowing the filaments to cool and (at least partially) solidify to form filaments, with the filaments passing through an air space (which may contain streams of moving air) to assist in cooling and solidifying the filaments, and with the thus-formed fibers then passing through an attenuation (i.e., drawing) unit to draw the fibers.

Melt spinning can be distinguished from melt blowing, which involves the extrusion of molten filaments into converging high velocity air streams introduced by way of air-blowing orifices located in close proximity to the extrusion orifices. Melt spinning can also be distinguished from electrospinning in that electrospinning could be described as extruding out of a need a solvent solution. A modification of the spinneret results in multicomponent (e.g., core-sheath) fibers (See, e.g., U.S. Pat. No. 4,406,850 (Hills), U.S. Pat. No. 5,458,972 (Hagen), U.S. Pat. No. 5,411,693 (Wust), U.S. Pat. No. 5,618,479 (Lijten), and U.S. Pat. No. 5,989,004 (Cook)). Filaments according to the present disclosure can also be made by fibrillation of a film, which may provide filaments having a rectangular cross-section.

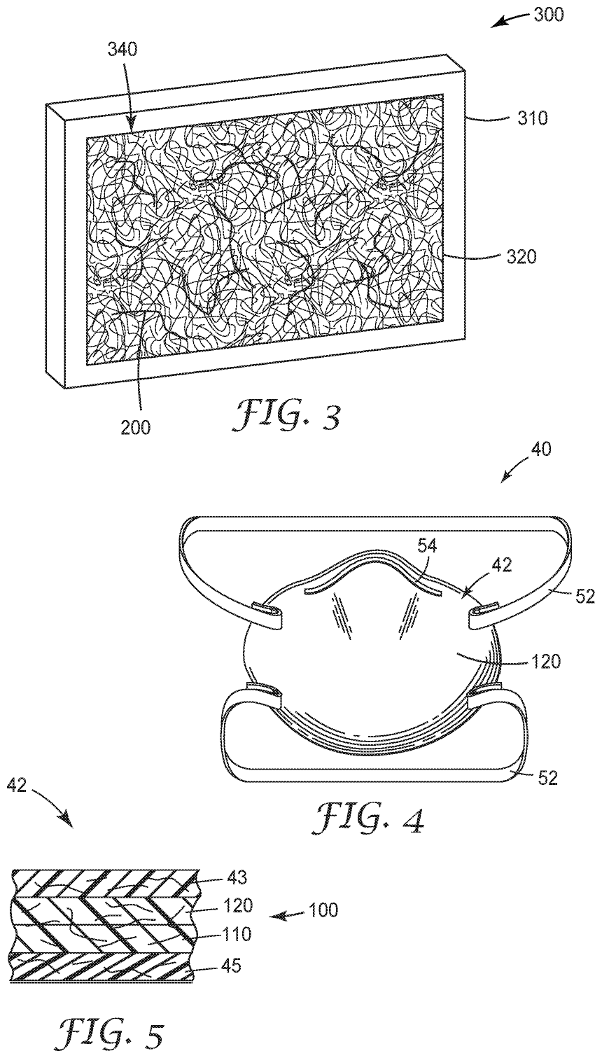

Core-sheath fibers as described above are useful for fabricating a prefilter assembly. Referring now to FIG. 3, exemplary prefilter assembly 300 comprises prefilter frame 310 and prefilter medium 340. Prefilter frame 310 has inlet opening 320 and outlet opening (not shown, but symmetrically opposite inlet opening 320). Prefilter medium 340 is retained by prefilter frame 310. Prefilter medium 340 comprises a nonwoven fibrous web that has an electret charge and comprises core-sheath fibers 200.

Applications for exemplary filter assemblies according to the present disclosure include HVAC filtration and respirators, for example.

As used herein, the term “respirator” means a system or device worn over a person's breathing passages to prevent contaminants from entering the wearer's respiratory tract and/or protect other persons or things from exposure to pathogens or other contaminants expelled by the wearer during respiration, including, but not limited to filtering face masks.

Referring now to FIGS. 4 and 5, exemplary respirator 40 comprises mask body 42 which can be of curved, hemispherical shape or may take on other shapes as desired (e.g., see U.S. Pat. No. 5,307,796 (Kronzer et al.) and U.S. Pat. No. 4,827,924 (Japuntich)). In mask 40, filter assembly 100 (see FIG. 1) according to the present disclosure is sandwiched between cover web 43 and inner shaping layer 45. Shaping layer 45 provides structure to the mask body 42 and support for filter media 200.

Shaping layer 45 may be located on either side of the filter assembly 100 and can be made, for example, from a nonwoven web of thermally-bondable fibers molded into a cup-shaped configuration. The shaping layer can be molded in accordance with known procedures (e.g., see U.S. Pat. No. 5,307,796 (Kronzer et al.), the disclosure of which is incorporated herein by reference. The shaping layer or layers typically are made of bicomponent fibers that have a core of a high melting materials such as polyethylene terephthalate, surrounded by a sheath of lower melting material so that when heated in a mold, the shaping layer conforms to the shape of the mold and retains this shape when cooled to room temperature. When pressed together with another layer, such as the filter layer, the low melting sheath material can also serve to bond the layers together.

To hold the mask 40 snugly on the wearer's face, masks body 42 can have straps 52, tie strings, a mask harness, etc. attached thereto. A pliable soft band 54 of metal, such as aluminum, can be provided on mask body 42 to allow it to be shaped to hold the mask 40 in a desired fitting relation ship on the nose of the wearer (e.g., see U.S. Pat. No. 5,558,089 (Castiglione et al.)). Respirators according to the present disclosure may also include additional layers, valves (e.g., see U.S. Pat. No. 5,509,436 (Japuntich et al.), molded face pieces, etc. Examples of respirators that can incorporate the electret filter media according to the present disclosure include those described in U.S. Pat. No. 4,536,440 (Berg), U.S. Pat. No. 4,827,924 (Japuntich), U.S. Pat. No. 5,325,892 (Japuntich et al.), U.S. Pat. No. 4,807,619 (Dyrud et al.), U.S. Pat. No. 4,886,058 (Brostrom et al.), and RE35,062 (Brostrom et al.).

### SELECT EMBODIMENTS OF THE PRESENT DISCLOSURE

In a first embodiment, the present disclosure provides a filter assembly comprising:

an air filter medium comprising a first nonwoven fibrous web having a first electret charge; and

a prefilter medium comprising a second nonwoven fibrous web having a second electret charge and comprising poly(4-methylpentene) and an electrostatic charging additive,

wherein the filter assembly is configured such that air passing through the prefilter medium is directed through the air filter medium.

In a second embodiment, the present disclosure provides a filter assembly according to the first embodiment, wherein the second nonwoven fibrous web comprises core-sheath fibers, the core-sheath fibers comprising:

a fiber core having a poly(4-methylpentene) sheath layer disposed thereon; and

the electrostatic charging additive, wherein the electrostatic charging additive is contained in at least one of the fiber core or the sheath layer.

In a third embodiment, the present disclosure provides a filter assembly according to the first or second embodiment, wherein the electrostatic charging additive is present in the fiber core.

In a fourth embodiment, the present disclosure provides a filter assembly according to any of the first to third embodiments, wherein the electrostatic charging additive is present in the sheath layer.

In a fifth embodiment, the present disclosure provides a filter assembly according to any of the first to third embodiments, wherein the electrostatic charging additive is present in both of the fiber core and the sheath layer.

In a sixth embodiment, the present disclosure provides a filter assembly according to any of the second to fifth embodiments, wherein the fiber core comprises polypropylene, polyester, polystyrene, or polyethylene.

In a seventh embodiment, the present disclosure provides a filter assembly according to any of the second to sixth embodiments, wherein the sheath layer comprises 1 to 40 percent by weight of the thermoplastic core-sheath fiber.

In an eighth embodiment, the present disclosure provides a filter assembly according to any of the first to seventh embodiments, wherein the electrostatic charging additive is selected from the group consisting of pigments, light stabilizers, primary and secondary antioxidants, metal deactivators, hindered amines, hindered phenols, metal salts, phosphite triesters, phosphoric acid salts, fluorine-containing compounds, and combinations thereof.

In ninth embodiment, the present disclosure provides a filter assembly according to any of the first to eighth embodiments, wherein the first nonwoven fibrous web comprises at least one of polypropylene, polyester, polystyrene (polylactic acid, polyethylene terephthalate, polycaprolactone), poly(4-methyl-1-pentene), or polyethylene.

In a tenth embodiment, the present disclosure provides a respirator comprising the filter assembly of any of the first to ninth embodiments.

In an eleventh embodiment, the present disclosure provides a prefilter assembly comprising:

a prefilter frame having an inlet opening and an outlet opening; and

a prefilter medium retained by prefilter frame, the prefilter medium comprising a nonwoven fibrous web having an electret charge and comprising:
a thermoplastic core-sheath fiber comprising a fiber core having a sheath layer comprising poly(4-methylpentene) disposed thereon; and

an electrostatic charging additive, wherein the electrostatic charging additive is contained in at least one of the fiber core or the sheath layer.

In a twelfth embodiment, the present disclosure provides a prefilter assembly according to the eleventh embodiment, wherein the fiber core comprises polypropylene, polyester, polystyrene, or polyethylene.

In a thirteenth embodiment, the present disclosure provides a prefilter assembly according to the eleventh or twelfth embodiment, wherein the electrostatic charging additive is selected from the group consisting of pigments, light stabilizers, primary and secondary antioxidants, metal deactivators, hindered amines, hindered phenols, metal salts, phosphite triesters, phosphoric acid salts, fluorine-containing compounds, and combinations thereof.

In a fourteenth embodiment, the present disclosure provides a prefilter assembly according to any of the eleventh to thirteenth embodiments, wherein the sheath layer comprises 1 to 40 percent by weight of the thermoplastic core-sheath fiber.

In a fifteenth embodiment, the present disclosure provides a prefilter assembly according to any of the eleventh to fourteenth embodiments, wherein the fiber core has an electret charge.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. In these Examples “CE-” indicates a comparative example and “E-” indicates an example. Further, “EFD” refers to Effective Fiber Diameter.

TABLE 1

| POLYMER | GRADE | ABBREVIATION | SUPPLIER |
|---|---|---|---|
| Poly(4-methyl-1-pentene) | TPX DX820 | PMP-1 | Mitsui Chemicals, Inc., Tokyo, |
| | | | Japan |
| | TPX DX470 | PMP-2 | Mitsui Chemicals, Inc. |
| Polypropylene | MF-650X | PP-1 | LyondellBasell Industries N.V., |
| | | | Rotterdam, The Netherlands |
| | Total 3860X | PP-2 | Total Petrochemicals, Brussells, |
| | | | Belgium |
| | Total 3766 | PP-3 | Total Petrochemicals |
| Polystyrene | PS U249 | PS-1 | Unigel, Sao Paulo, Brazil, |
| Polylactic Acid | 6202D | PLA-1 | NatureWorks, Minnetonka, |
| | | | Minnesota |

TABLE 2

| ADDITIVE | SUPPLIER | ABBREVIATION |
|---|---|---|
| Phenol 9 - Ca | Prepared as described in U.S. | CA-1 |
| | Pat. Appln. Publ. No. | |
| | 2019/0003112 (Schultz et al.) | |
| 2,4-Bis(octylthio)-6-(4-hydroxy-3,5-di- | BASF SE, Ludwigshafen am | CA-2 |
| tert-butylanilino)-1,3,5-triazine | Rhein, Germany | |
| (Irganox565/CAS No. 991-84-4) | | |
| 1,3-Dihydro-4(or 5)-methyl-2H- | Vanderbilt Chemicals, LLC, | CA-3 |
| benzimidazole-2-thione, zinc salt | Norwalk, Connecticut | |
| (ZMTI/CAS No. 61617-00-3) | | |
| N,N′-bis(2,2,6,6-tetramethylpiperidin-4- | BASF SE | CA-4 |
| yl)hexane-1,6-diamine; 2,4,6-trichloro- | | |
| 1,3,5-triazine; 2,4,4-trimethylpentan-2- | | |
| amine | | |
| (Chimassorb944/CAS No. 71878-19-8) | | |
| Poly [(6-morpholino-s-triazine-2,4- | Cytec Industries, Inc., Saddle | CA-5 |
| diyl)[2,2,6,6-tetramethyl-4-piperidyl) | Brook, New Jersey | |
| imino]-hexamethylene[(2,2,6,6- | | |
| tetramethyl-4-piperidyl) imino]] | | |
| (Cyasorb 3346/CAS No. 82451-48-7) | | |
| Poly((6-morpholino-s-triazine-2,4- | Cytec Industries, Inc. | CA-6 |
| diyl)(1,2,2,6,6-pentamethyl-4- | | |
| piperidyl)imino)hexamethylene | | |
| (1,2,2,6,6-pentamethyl-4- | | |
| piperidyl)imino)) | | |
| (Cyasorb 3529/CAS No. 193098-40-7) | | |

### Fiber & Nonwoven Fibrous Web Sample Preparation

### Step A—Nonwoven Fibrous Web Formation:

Nonwoven fibrous webs were formed by first dry blending a compounded charging additive with one of the thermoplastic resin grades, and then extruding fibers to form a BMF or spunbond web. In the case of sheath/core samples, the sheath and core may individually contain one additive, a blend of additives, or no additives in some case.

### Step B—Electret Preparation:

Nonwoven fibrous webs prepared in Step A above were charged by one of three electret charging methods: corona charging, corona pre-treatment and hydrocharging, or hydrocharging. The methods are designated as Charging Method C, and H, respectively.

### Charging Method C—Corona Charging:

Nonwoven fibrous webs prepared in Step A (above) were charged by DC corona discharge. The corona charging was accomplished by passing the web on a grounded surface under a corona wire source with a corona current of about 0.01 milliamp per centimeter of discharge source length at a rate of about 3 centimeters per second. The corona source was about 3.5 centimeters above the grounded surface on which the web was carried. The corona source was driven by a positive DC voltage.

### Charging Method H—Hydrocharging:

A fine spray of high purity water having a conductivity of less than 5 microsiemens per centimeter was continuously generated from a nozzle operating at a pressure of 896 kilopascals (130 psig) and a flow rate of approximately 1.4 liters/minute. Nonwoven fibrous webs prepared in Step A (above) were conveyed by a porous belt through the water spray at a speed of approximately 10 centimeters/second while a vacuum simultaneously drew the water through the web from below. Each melt-blown web was run through the hydrocharger twice (sequentially once on each side) and then allowed to dry completely overnight prior to filter testing.

### Filtration Performance Test Method, Non-Woven Melt-Blown Microfiber Webs

### Initial Filtration Performance:

The samples were tested for % aerosol penetration (% Pen) and pressure drop (ΔP), and the quality factor (QF) was calculated from these two values. The filtration performance (% Pen and QF) of the nonwoven microfiber webs were evaluated using an Automated Filter Tester AFT Model 8130 (available from TSI, Inc., St. Paul, Minn.) using dioctyl phthalate (DOP) as the challenge aerosol and a pressure transducer that measured pressure drop (ΔP (mm of H₂O)) across the filter. The DOP aerosol was nominally a monodisperse 0.33 micrometer mass median (MMD) diameter having an upstream concentration of 50-200 mg/m³ and a target of 100 mg/m³. The aerosol was forced through a sample of filter media at a calibrated flow rate of 85 liters/minute (face velocity of 13.8 cm/s). The aerosol ionizer was turned off for these tests. The total testing time was 23 seconds (rise time of 15 seconds, sample time of 4 seconds, and purge time of 4 seconds). The concentration of DOP aerosols was measured by light scattering both upstream and downstream of the filter media using calibrated photometers. The DOP % Pen is defined as: % Pen=100×(DOP concentration downstream/DOP concentration upstream). For each material, 6 separate measurements were made at different locations on the melt-blown web and the results were averaged.

The % Pen and ΔP were used to calculate a QF by the following formula:

QF=−ln(% Pen/100)/ΔP

where ln stands for the natural logarithm. A QF for an as-prepared sample is referred to as Q0. An additional test is to thermally age six samples prior to measuring QF at 72 C for 3 days. The average of these six QFs are denoted Q3.

### Loading Test

DOP loading is a direct measurement of the resistance of a filter medium to degradation due to exposure to an oily mist aerosol. The penetration through, and the pressure drop across, a sample were monitored during prolonged exposure of the sample to a DOP aerosol under specified conditions. Standard equipment and test procedures were used for measuring filter performance.

The measurements were made using an automated filter tester (AFT) Model 8130 that was set up with an oil aerosol generator. DOP % Penetration was calculated automatically by the AFT instrument, where the concentrations upstream and downstream were measured by light scattering. Measurements were performed with the aerosol neutralizer turned off and a flow rate through the sample of 85 liters per minute (L/min), unless otherwise indicated.

Samples were tested in the following manner. Samples were cut and mounted in a sample holder such that an 11.45 cm (4.5 inch) diameter portion of the sample was exposed to the aerosol. The face velocity was 13.8 centimeters/second (cm/sec). Each test was continued until the exposure on the sample was exposed to 100 mg or 200 mg DOP, depending on the specific test. The DOP % Penetration and corresponding Pressure Drop data were determined by the AFT and transmitted to an attached computer where the data was stored.

QFs may also be calculated from the loading curve, using the initial DOP penetration and DOP penetrations after loadings of 100 mg and 200 mg. These values are referred to as Q0′, Q100, and Q200, respectively.

### Determination of Effective Fiber Diameter (EFD) and Solidity:

Effective Fiber Diameter and Solidity were determined according to methods as described in Davies, C. N., The Separation of Airborne Dust and Particulates, Institution of Mechanical Engineers, London Proceedings, IB (1952), incorporated herein by reference.

### Preparation of Webs W1-W9

Sheath-core fibers were prepared with an electrostatic-charging additive in the sheath, in the core, and combinations thereof. The initial performance was measured by the initial Quality-factor, Q0, and the Quality-factor after aging, Q3. The web properties, compositions, charging method, and filtration performance are listed in Table 3 (Below), wherein all of the webs were spunbond webs.

TABLE 3

| | BASIS | | | ΔP, | | | | | | | | |
|---|---|---|---|---|---|---|---|---|---|---|---|---|
| | WEIGHT, | | EFD, | mm of | SHEATH | | | CORE | | CHARGING | | |
| WEB | gsm | SOLIDITY | microns | H₂O | Resin | Additive | % sheath | Resin | Additive | METHOD | Q0 | Q3 |
| W1 | 120 | | | | PMP-1 | None | 20 | PP-3 | None | C | 0.30 | 0.22 |
| W2 | 120 | | | | PMP-1 | 0.15% CA-3 | 40 | PP-3 | None | C | 0.29 | 0.27 |
| W3 | 65 | | | | PMP-1 | 0.15% CA-3 | 20 | PP-3 | None | C | 0.39 | 0.36 |
| W4 | 120 | | | | PMP-1 | 0.15% CA-1 | 20 | PP-3 | None | C | 0.32 | 0.34 |
| W5 | 65 | | | | PMP-1 | 0.15% CA-1 | 20 | PP-3 | None | C | 0.41 | 0.47 |
| W6 | 120 | | | | PMP-1 | 0.15% CA-1 | 20 | PP-3 | None | C | 0.21 | 0.20 |
| W7 | 120 | | | | PMP-1 | None | 20 | PP-3 | 0.1% CA-1 | C | 0.31 | 0.29 |
| W8 | 120 | | | | PMP-1 | 0.40% CA-4 + | 20 | PS-1 | None | C | 0.31 | 0.25 |
| | | | | | | 0.1% CA-3 | | | | | | |
| W9 | 79 | 10% | 26.3 | 0.7 | PMP-1 | 0.5% CA-2 | 20 | PP-2 | 0.1% CA-1 | C | 0.47 | 0.47 |

### Preparation of Webs W10-W16

These examples report oil loading results for PP webs and PMP webs. The values reported are the % penetration at 0 mg, 100 mg, and 200 mg of DOP exposure. Also measured was how rapidly the charge was deteriorating by reporting the % Chg @ 100 mg and % Chg @ 200 mg, where these values are reported as:

% Chg @100=(% Pen_{100 mg}−% Pen_{0 mg})/% Pen_{100 mg}×100%

Chg @200=(% Pen_{200 mg}−% Pen_{0 mg})/% Pen_{100 mg}×200

The web properties, compositions, and results for the oil loading of 2-layer constructions are reported in Tables 4 and 5. The results show the utility of PMP webs as prefilters.

TABLE 4

| | BASIS | ΔP, | | | | | | | | |
|---|---|---|---|---|---|---|---|---|---|---|
| | WEIGHT, | mm of | % | EFD, | SHEATH | | | CORE | | WEB |
| WEB | gsm | H₂O | Solidity | microns | RESIN | ADDITIVE | WT. % | RESIN | ADDITIVE | TYPE |
| W10 | 117 | 2.6 | 10.8 | 17.1 | PP-3 | 1% CA-5 | 50 | PP-3 | | SB |
| W11 | 117 | 2.6 | 10.8 | 17.1 | PP-3 | 1% CA-5 | 50 | PP-3 | | SB |
| W12 | 122 | 2.7 | 11.2 | 17.4 | PP-3 | 1% CA-6 | 50 | PP-3 | | SB |
| W13 | 119 | 2.8 | 12.7 | 18.1 | PMP-1 | 0.15% CA-1 | 40 | PP-3 | | SB |
| W14 | 119 | 2.8 | 13.6 | 18.4 | PMP-1 | 0.15% CA-3 | 40 | PP-3 | | SB |
| W15 | 120 | 2.9 | 12.2 | 17.8 | PMP-1 | 0.8% CA-5 | 40 | PP-3 | | SB |
| W16 | 65 | 7.1 | 10.2 | 7.3 | PMP-1 | none | 50 | PP-1 | 0.15% CA-1 | BMF |

TABLE 5

| | | ΔP, | | | | | |
|---|---|---|---|---|---|---|---|
| | CHARGING | mm of | | | | | |
| WEB | METHOD | H₂O | % Pen0 | % Pen100 | % Pen200 | % Chg @ 100 | % Chg @ 200 |
| W10 | C | 4.9 | 21.8 | 47.4 | 70.8 | 117.4 | 224.8 |
| W11 | H | 5.0 | 5.1 | 22.0 | 40.4 | 333.1 | 695.3 |
| W12 | H | 4.4 | 3.9 | 20.7 | 41.6 | 433.5 | 972.2 |
| W13 | C | 5.3 | 22.4 | 28.5 | 34.3 | 27.2 | 53.1 |
| W14 | C | 4.9 | 25.3 | 32.1 | 38.2 | 26.9 | 51.0 |
| W15 | C | 4.7 | 23.9 | 31.4 | 39.9 | 31.4 | 66.9 |
| W16 | C | 7.5 | 27.1 | 33.0 | 43 | 21.8 | 58.7 |

### Comparative Examples Ce-1 and Ce-2 and Examples E-1 and E-2

In these examples, the effect of multilayer loading on oil penetration shows that high surface area, charged PMP webs can have decreasing aerosol penetration. The data, along with non-PMP comparisons are reported in Table 6 (below).

TABLE 6

| | | NUMBER | ΔP, | | | | | |
|---|---|---|---|---|---|---|---|---|
| | | OF | mm of | | | | | |
| EXAMPLE | DESCRIPTION | LAYERS | H₂O | % Pen0 | % Pen100 | % Pen200 | % Chg @ 100 | % Chg @ 200 |
| CE-1 | W10 | 2 | 4.9 | 21.8 | 47.4 | 72.4 | 117.4 | 232.1 |
| | | 4 | 8.9 | 11.5 | 23.0 | 30.8 | 100.0 | 167.8 |
| CE-2 | W11 | 1 | 2.2 | 20.0 | 49.3 | 69.2 | 146.5 | 246.0 |
| | | 3 | 7.2 | 1.4 | 6.2 | 12.6 | 352.6 | 819.7 |
| | | 4 | 9.2 | 0.3 | 1.8 | 4.4 | 489.2 | 1364.6 |
| E-1 | W15 | 2 | 4.7 | 23.9 | 31.3 | 39.9 | 31.0 | 66.9 |
| | | 4 | 10.1 | 7.1 | 8.4 | 7.0 | 17.1 | −1.5 |
| E-2 | W7 | 2 | 4.2 | 25.1 | 30.9 | 34.6 | 23.1 | 37.8 |
| | | 4 | 10.9 | 4.90 | 4.5 | 3.7 | −7.8 | −24.9 |

### Preparation of Webs W17-W27

In these examples the Q0, Q100, and Q200 values computed from oil-loading values for webs without charging additives. All of the constructions are sheath-core with a PMP sheath. The web properties are listed in Table 7 and the results are listed in Table 8.

TABLE 7

| | BASIS | | | ΔP, | | SHEATH, | | | | |
|---|---|---|---|---|---|---|---|---|---|---|
| | WEIGHT, | % | EFD, | mm of | SHEATH | wt. % of | SHEATH | CORE | CORE | NO. OF |
| WEB | gsm | SOLIDITY | microns | H₂O | RESIN | fiber | ADDITIVE | RESIN | ADDITIVE | LAYERS |
| W17 | 118 | 15.0 | 18.4 | 2.9 | PMP-1 | 20 | | PP-2 | | 1 |
| W18 | 118 | 15.0 | 18.4 | 2.9 | PMP-1 | 20 | | PP-2 | | 2 |
| W19 | 118 | 16.1 | 18.6 | 3.1 | PMP-1 | 10 | | PP-2 | | 2 |
| W20 | 117 | 16.8 | 18.4 | 3.3 | PMP-1 | 5 | | PP-2 | | 2 |
| W21 | 121 | 15.0 | 18.8 | 2.9 | PMP-1 | 20 | | PP-2 | 0.15% CA-1 | 1 |
| W22 | 121 | 15.0 | 18.8 | 2.9 | PMP-1 | 20 | | PP-2 | 0.15% CA-1 | 2 |
| W23 | 117 | 16.1 | 19.2 | 3.0 | PMP-1 | 10 | | PP-2 | 0.15% CA-1 | 2 |
| W24 | 117 | 15.8 | 18.9 | 2.9 | PMP-1 | 5 | | PP-2 | 0.15% CA-1 | 2 |
| W25 | 97 | 12.8 | 16.8 | 2.6 | PMP-1 | 20 | | PP-2 | 0.15% CA-1 | 1 |
| W26 | 100 | 12.1 | 21.9 | 1.5 | PMP-1 | 20 | | PP-2 | 0.15% CA-1 | 1 |
| W26 | 80.2 | 9.8 | 26.7 | 0.7 | PMP-1 | 20 | | PP-2 | 0.15% CA-1 | 1 |
| W27 | 78.8 | 10.0 | 26.3 | 0.7 | PMP-1 | 20 | 0.5% CA-2 | PP-2 | 0.15% CA-1 | 1 |

TABLE 8

| | ΔP, | | | | | | |
|---|---|---|---|---|---|---|---|
| | mm of | | | | | | |
| WEB | H₂O | % Pen0 | % Pen100 | % Pen200 | Q0′ | Q100 | Q200 |
| W17 | 2.5 | 68.8 | 71.1 | | 0.15 | 0.14 | |
| W18 | 5.6 | 34.3 | 43.9 | 54.8 | 0.19 | 0.15 | 0.11 |
| W19 | 5.6 | 43.8 | 53.9 | 69.0 | 0.15 | 0.11 | 0.07 |
| W20 | 6.0 | 43.1 | 57.8 | 72.2 | 0.14 | 0.09 | 0.05 |
| W21 | 2.6 | 53.0 | 59.3 | | 0.24 | 0.20 | |
| W22 | 5.0 | 25.8 | 32.1 | 43.4 | 0.27 | 0.23 | 0.17 |
| W23 | 5.1 | 27.8 | 40.1 | 51.3 | 0.25 | 0.18 | 0.13 |
| W24 | 5.9 | 27.5 | 37.8 | 53.5 | 0.22 | 0.16 | 0.11 |
| W25 | 2.4 | 51.7 | 61.2 | | 0.27 | 0.20 | |
| W26 | 1.5 | 57.3 | 64.9 | | 0.37 | 0.29 | |
| W26 | 0.8 | 60.1 | 70.1 | | 0.64 | 0.44 | |
| W27 | 0.7 | 69.0 | 74.7 | | 0.53 | 0.42 | |

### Preparation of Webs W28 and W29, Comparative Examples Ce-3 to Ce-6, and Examples E-3 to E-8

In these examples, select nonwoven fibrous webs were used as prefilters for an electret-PP web. Most of the webs used as prefilters have been described above. For the prefilter webs that have not been described above, information is given below in Table 9. Information about the laminate constructions are and the results are given in Table 10.

TABLE 9

| | | | BASIS | | | ΔP, | | | | |
|---|---|---|---|---|---|---|---|---|---|---|
| | WEB | CHARGING | WEIGHT, | % | EFD, | mm of | SHEATH | | CORE | |
| WEB | TYPE | METHOD | gsm | SOLIDITY | microns | H₂O | wt. % | resin | resin | additive |
| W28 | SB | C | 57 | 13.6 | 15 | 1.9 | 20 | PMP-1 | PP-2 | 0.15% CA-1 |
| W29 | SB | C | 56 | 10.7 | 23 | 0.7 | 20 | PMP-1 | PP-2 | 0.15% CA-1 |

TABLE 10

| | PRIMARY FILTER | | | | | | | |
|---|---|---|---|---|---|---|---|---|
| | | | Basis | ΔP | | | PREFILTER | |
| | No. of | EFD, | Weight, | mm of | | | | Prefilter |
| EXAMPLE | Layers | microns | gsm | H₂O | Resin | Additive | Web | Layers |
| CE-3 | 1 | 7.9 | 57 | 4.0 | PP-1 | 1% CA-4 | None | |

| | | | | |
|---|---|---|---|---|
| CE-4 | 2 | same as CE-3 | None | |
| CE-5 | 1 | same as CE-3 | W11 | 1 |
| CE-6 | 2 | same as W11 | none | |
| E-3 | 1 | same as CE-3 | W7 | 1 |
| E-4 | 1 | same as CE-3 | W7 | 2 |
| E-5 | 1 | same as CE-3 | W29 | 1 |
| E-6 | 1 | same as CE-3 | W30 | 1 |
| E-7 | 1 | same as CE-3 | W29 | W29 and W30 |
| | | | W30 | where W29 contacts |
| | | | | the primary filter |
| E-8 | 1 | same as W11 | W14 | 1 |

TABLE 11

| | ΔP, | | | |
|---|---|---|---|---|
| EXAMPLE | mm of H₂O | % Pen0 | % Pen100 | % Pen200 |
| CE-3 | 7.7 | 0.21 | 14.7 | 44.3 |
| CE-4 | 17.1 | 0.00 | .20 | 3.37 |
| CE-5 | 10.0 | 0.10 | 5.27 | 27.7 |
| CE-6 | 5.0 | 5.08 | 22.0 | 40.4 |
| E-3 | 10.2 | 0.09 | 2.30 | 8.5 |
| E-4 | 12.9 | 0.08 | .64 | 1.2 |
| E-5 | 9.4 | 0.32 | 8.71 | 28.0 |
| E-6 | 8.2 | 0.34 | 10.4 | 32.3 |
| E-7 | 10.3 | 0.29 | 3.03 | 7.78 |
| E-8 | 4.9 | 12.9 | 22.7 | 26.7 |

### Comparative Example CE-7 and Example 9

Table 12 (below) reports results for oil loading out to 1,000 mg of DOP for filter constructions CE-15 and E-29.

TABLE 12

| | | | ΔP, | | |
|---|---|---|---|---|---|
| | PRIMARY | PRE- | mm of | % Pen @ | % Pen @ |
| EXAMPLE | FILTER | FILTER | H₂O | 0 mg | 1000 mg |
| CE-7 | CE-3 | 4 Layers | 17.5 | 0.003 | 50.2 |
| | | of W11 | | | |
| E-9 | CE-3 | 4 Layers | 13.2 | 0.033 | 28.3 |
| | | of W2 | | | |

All cited references, patents, and patent applications in this application that are incorporated by reference, are incorporated in a consistent manner. In the event of inconsistencies or contradictions between portions of the incorporated references and this application, the information in this application shall control. The preceding description, given in order to enable one of ordinary skill in the art to practice the claimed disclosure, is not to be construed as limiting the scope of the disclosure, which is defined by the claims and all equivalents thereto.

1. A filter assembly comprising:
an air filter medium comprising a first nonwoven fibrous web having a first electret charge; and
a prefilter medium comprising a second nonwoven fibrous web having a second electret charge and comprising poly(4-methylpentene) and an electrostatic charging additive, wherein the second nonwoven fibrous web comprises core-sheath fibers comprising a fiber core having a poly(4-methylpentene) sheath layer disposed thereon, wherein the electrostatic charging additive is contained in the fiber core, and
wherein the filter assembly is configured such that air passing through the prefilter medium is directed through the air filter medium.

2. (canceled)

3. The filter assembly of claim 1, wherein the electrostatic charging additive is present in the fiber core.

4. (canceled)

5. (canceled)

6. The filter assembly of claim 1, wherein the fiber core comprises polypropylene, polyester, polystyrene, or polyethylene.

7. The filter assembly of claim 1, wherein the sheath layer comprises 1 to 40 percent by weight of the core-sheath fiber.

8. The filter assembly of claim 1, wherein the electrostatic charging additive is selected from the group consisting of pigments, light stabilizers, primary and secondary antioxidants, metal deactivators, hindered amines, hindered phenols, metal salts, phosphite triesters, phosphoric acid salts, fluorine-containing compounds, and combinations thereof.

9. The filter assembly of claim 1, wherein the first nonwoven fibrous web comprises at least one of polypropylene, polyester, polystyrene, poly(4-methyl-1-pentene), or polyethylene.

10. A respirator comprising the filter assembly of claim 1.

11. A prefilter assembly comprising:
a prefilter frame having an inlet opening and an outlet opening; and
a prefilter medium retained by prefilter frame, the prefilter medium comprising a nonwoven fibrous web having an electret charge and comprising:
a thermoplastic core-sheath fiber comprising a fiber core having a sheath layer comprising poly(4-methylpentene) disposed thereon; and
an electrostatic charging additive, wherein the electrostatic charging additive is contained in the fiber core.

12. The prefilter assembly of claim 11, wherein the fiber core comprises polypropylene, polyester, polystyrene, or polyethylene.

13. The prefilter assembly of claim 11, wherein the electrostatic charging additive is selected from the group consisting of pigments, light stabilizers, primary and secondary antioxidants, metal deactivators, hindered amines, hindered phenols, metal salts, phosphite triesters, phosphoric acid salts, fluorine-containing compounds, and combinations thereof.

14. The prefilter assembly of claim 11, wherein the sheath layer comprises 1 to 40 percent by weight of the thermoplastic core-sheath fiber.

15. (canceled)
